(19) United States
(12) Patent Application Publication
(10) Pub. No.: US 2012/0241995 A1
(43) Pub. Date: Sep. 27, 2012

(54) DEVICE AND METHOD FOR THE PRODUCTION OF A POLYMER GRANULATE

(75) Inventors: Klaus-Karl Wasmuht, Ellingen (DE); Eckehard Adrian, Eutin (DE); Johannes Preiss, Regensburg (DE)

(73) Assignee: KRONES AG, Neutraubling (DE)

(21) Appl. No.: 13/370,427

(22) Filed: Feb. 10, 2012

(30) Foreign Application Priority Data
Feb. 11, 2011 (DE) 10201103986.4

(51) Int. Cl. B29B 9/06

(52) U.S. Cl. 264/142; 425/308

(57) ABSTRACT

A device for the production of a polymer granulate, including a means for continuously producing a polymer strand from a polymer melt and a cutting means for cutting the resultant polymer strand, with the cutting means arranged relative to the means for producing the polymer strand in a distance-variable manner. Also, a method for the production of a polymer granulate, including continuously producing a polymer strand from a polymer melt and of cutting the resultant polymer strand into a polymer granulate, where the period between the production of the polymer strand and the cutting step is variably adjustable by varying the distance of a cutting means relative to a means for producing the polymer strand.

### CROSS-REFERENCE TO RELATED APPLICATION

The present application claims the benefit of priority of German Application No. 102011003986.4, filed Feb. 11, 2012. The entire text of the priority application is incorporated herein by reference in its entirety.

### FIELD OF THE DISCLOSURE

The disclosure relates to a device for the production of a polymer granulate, comprising a means for continuously producing a polymer strand from a polymer melt and a cutting means for cutting the resultant polymer strand, and to a method for the production of a polymer granulate, comprising the steps of continuously producing a polymer strand from a polymer melt and cutting the resultant polymer strand into a polymer granulate.

### BACKGROUND

Polymer granulates are usually produced by means of a continuous screw kneading and extrusion method, where a solid polymer product is converted into the melt by supplying thermal energy and/or applying mechanical shear forces, and the resultant polymer strand is cut up into a polymer granulate in a cutting process. In general, the granulation process can be divided into two sub-classes.

Firstly, the cutting process can be carried out in the melt, immediately after the polymer strand emerges from the screw kneading and extrusion device. In particular, the underwater granulation may be mentioned, which is described, for example, in DE 20 300 009 U1, U.S. Pat. No. 6,217,802 B1, WO 01/94088 A2 or DE 69 621 101 T2.

Secondly, the cutting process may be carried out after the polymer strand has been cooled down and solidified, i.e. the granulation process is a so-called solid-matter granulation, where the already cooled solid polymer strand is cut up into a granulate, the so-called pellets, by a cutter. In the solid-matter granulation according to the prior art the conveyed strands are always cut at the same point in time, which is determined by the cooling section, i.e. by the distance between the extruder and the cutter.

Especially for the production of a PET granulate conventional plants include a subsequent crystallization unit, which is operated inline, and where the granulate initially present in an amorphous form is further cooled down slowly after the cutting process, so that the polymer material in the granulate may crystallize. The cutting step to obtain the polymer granulate is carried out at an as high as possible temperature, allowing the use of residual heat in the granulate for the subsequent crystallization step. If the cooling rate of the polymer strand is insufficient, however, there is the problem that the granules stick together and agglomerate because the temperature of the polymer strand had not been low enough at the time of the cutting process. Frequently, a sticky and agglomerated granulate cannot be processed further, that is, must be regarded as waste. In addition, the device may become clogged, resulting in the abortion of the granulation process for cleaning purposes.

In order to avoid the above-mentioned disadvantages it is frequently provided in conventional methods, for safety reasons, that the temperature of the polymer strand to be cooled down is further reduced prior to the cutting step, to a greater extent than would actually be necessary. This safety precaution is necessary in particular against the backdrop of varying polymer properties, i.e. inhomogeneities of the material composition of the polymer strand, since such inhomogeneities are associated with a variability of the glass transition temperature Tg. This, again, requires an extension of the cooling section and/or an additional reduction of the cooling temperature, so that the cooling process according to the prior art is associated with a high energy input. In particular if a device comprises a subsequent crystallization unit, and if the temperature of the polymer granulate is too low during the cutting step, it may also happen that the crystallization of the polymer material in the granulate is rendered more difficult or is impossible without the additional supply of thermal energy, so that the conventional plants are improvable from an energetic point of view.

### SUMMARY OF THE DISCLOSURE

One aspect of the present disclosure is to provide a device and a method for the production of a polymer granulate which, in comparison with conventional devices and methods, provide for the possibility to prevent the agglutination and agglomeration of the polymer pellets even in case of inhomogeneous material properties and, at the same time, provide for an efficient and inexpensive procedure. This includes a means for continuously producing a polymer strand from a polymer melt and a cutting means for cutting the resultant polymer strand, and includes the steps of continuously producing a polymer strand from a polymer melt and cutting the resultant polymer strand into a polymer granulate.

According to the disclosure this aspect is achieved by a cutting means arranged relative to the means for producing the polymer strand in a distance-variable manner. This distance variation is preferably made in an axial direction.

Such a relative movement of the cutting means allows the selective adjustment of the distance between the cutting means and the means for producing the polymer strand. This allows an optimization of the time of the cutting step and, thus, of the temperature of the polymer strand during the cutting step, so that the device can be realized with minimum space requirements and, thus, more cost-efficient. Also, this allows a targeted reaction on inhomogeneities of the polymer material, i.e. material properties of the polymer strand that are time-variable. If the cooling properties of the polymer strand differ over time, the cutting time is selectively varied by moving the cutting means relative to the means for producing the polymer strand, i.e. the temperature of the polymer strand at the time of the cutting step can be optimized, so as to ensure a consistently high quality of the pellets and prevent the polymer granulate from agglomerating/sticking together.

In a preferred embodiment the device is a screw kneading and extrusion device with a downstream solid-strand granulator, which allows an effective and inexpensive production of a polymer granulate.

In particular, it is preferred that the device comprises a means for cooling the polymer strand. This means is preferably a water cooling bath having a cooling device, which is at least partially arranged between the means for producing the polymer strand and the cutting means, so that the hot, liquid polymer strand is at least partially located in the cooling means after emerging from the extrusion device. Preferably, the step of cutting the polymer strand is carried out at a time at which the polymer strand is located in the means for cooling the polymer strand. Such an embodiment allows a particularly effective cooling of the polymer strand, resulting in an increased efficiency of the device.

In another preferred embodiment the device comprises a sensor for determining the temperature of the polymer strand directly ahead of the cutting means. The phrase “directly ahead of the cutting means” is variable with respect to the configuration of the device, but preferably implies a distance from the sensor to the cutting means of 10 cm or less, particularly preferably of 2 cm or less. The sensor type, i.e. the type of the temperature determination of the polymer strand is freely selectable. However, particularly preferred are non-contact, optical temperature sensors. Further, it is preferred that the device comprises a control unit, which is connected to the sensor and adjusts the means for cooling the polymer strand and/or the position of the cutting means.

This allows a particularly optimized granulation because the sensor determines the temperature of the polymer strand immediately prior to the cutting step, thereby allowing a particularly targeted movement of the cutting means, i.e. an optimization of the position of the cutter relative to the means for producing the polymer strand. Moreover, the use of the temperature as measured variable and controlled variable allows a targeted movement of the cutting means and/or the adjustment of the temperature of the means for cooling the polymer strand, which results in a particularly effective embodiment of the device.

It is particularly preferred that the cutting means and the sensor are arranged in one unit and are movable together, which guarantees that the distance between the position of the temperature determination and the cutting step is always constant.

According to the disclosure the above-described aspects are further achieved by a method in that the period between the production of the polymer strand and the cutting step is variably adjustable by varying the distance of a cutting means relative to a means for producing the polymer strand. The distance variation is preferably made in the axial direction.

Such an embodiment of the method allows the target-oriented variation and optimization of the relative distance between the means for producing the polymer strand and the cutting step so that, in comparison with conventional methods, the method can be carried out inexpensively and with a consistently high quality of the polymer granulate. Also, this allows a targeted reaction on inhomogeneities of the polymer material, so that a consistently high quality of the granulate is guaranteed because the polymer granulate is prevented from agglomerating/sticking together.

In particular, it is preferred that the method is a screw kneading and extrusion method with a downstream solid-matter granulation, which allows an effective and inexpensive embodiment of the method.

In a preferred embodiment the method additionally comprises a step of cooling the polymer strand, wherein the cooling step is carried out at least partially between the step of producing the polymer strand and the cutting step. In particular, it is preferred that the cooling step is carried out in a water cooling bath which is cooled by a cooling unit. Thus, the method can be carried out particularly effectively.

Another preferred embodiment is characterized in that the method comprises a step of determining the temperature of the polymer strand immediately prior to the cutting step, preferably by means of a non-contact, optical temperature measurement. A temperature measurement of such a type allows the variation of the period between the polymer strand emerging from the means for producing the polymer strand and the cutting means and, thus, the optimization of the position of the cutting step. In particular, it is preferred that the method according to the disclosure comprises a control step, in which the cooling temperature of the means for cooling the polymer strand and/or the distance between the means for producing the polymer strand and the cutting means are adjusted by a movement of the cutting means, wherein the temperature of the polymer strand immediately prior to the cutting step is used as control variable. Such a control allows the further optimization of the method, which ensures a cost-effective procedure and, at the same time, a consistently high quality of the polymer granulate.

In particular, it is preferred that the cooling temperature of the means for cooling the polymer strand and/or the distance between the means for producing the polymer strand and the cutting means is/are adjusted in such a way that the time-related temperature variation of the polymer strand immediately prior to the cutting step is in the range of 50° C. or less, preferably 30° C. or less, particularly preferably 10° C. or less.

This allows the target-oriented compensation of inhomogeneities in the material composition of the polymer, involving a different viscosity of the polymer strand and different glass temperatures, so that the quality of the method can be further improved.

It is particularly preferred that the polymer is a thermoplastic polymer, preferably a polyester, a polystyrene, a polyolefin, a polyamide or a polycarbonate, particularly preferably polyethylene terephthalate, polypropylene or polyethylene, or copolymers of these polymers.

### BRIEF DESCRIPTION OF THE DRAWINGS

The disclosure and its advantages will be explained in more detail by means of the illustrative embodiments and comparative examples shown in the accompanying drawings. In the drawings:

FIG. 1 shows a schematic sectional drawing of a device according to the disclosure;

FIG. 2 shows a schematic sectional drawing of a preferred embodiment of a device according to the disclosure.

### DETAILED DESCRIPTION OF THE PREFERRED EMBODIMENT

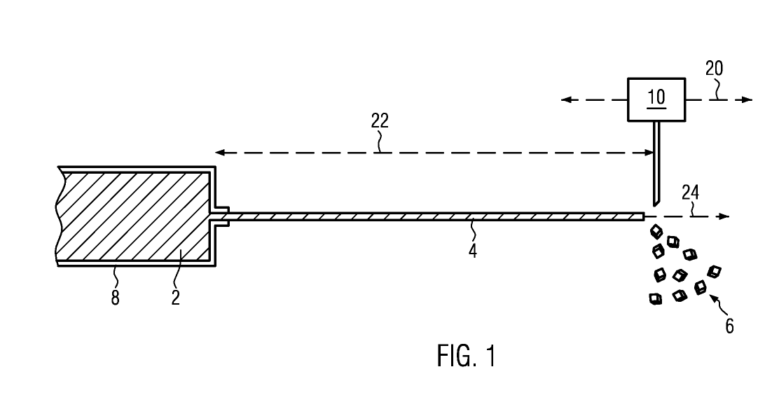

FIG. 1 schematically shows a device according to the disclosure, including a means 8 for continuously producing a polymer strand 4 from a polymer melt 2 located in the means 8. The polymer strand 4 emerges continuously in the movement direction 24. At the position of the cutting means 10 a polymer granulate 6 is produced by cutting the polymer strand 4. The cutting means 10 is movable in an axial direction, i.e. along the movement direction 20, in both directions relative to the movement direction 24 of the polymer strand 4. The distance 22 between the means 8 for producing the polymer strand 4 and the cutting means 10 can be varied by a movement of the cutting means 10.

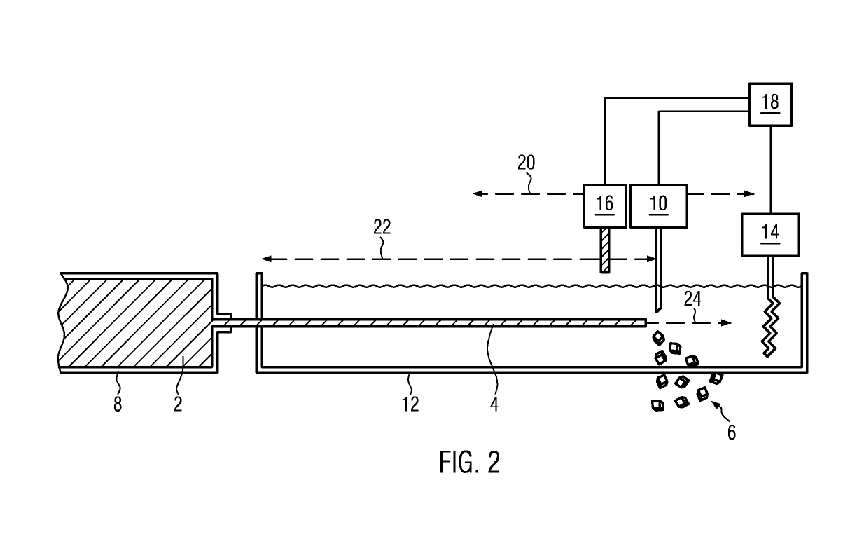

FIG. 2 represents a preferred embodiment of the device, which additionally comprises a water cooling bath 12 with a cooling unit 14 as a means for cooling the polymer strand 4. Furthermore, in this embodiment of the device, the cutting means 10 includes a sensor 16 forming a unit together with the cutting means 10. The sensor 6 is arranged to measure the temperature of the polymer strand 4 directly ahead of the position of the polymer strand 4 where the cutting means 10 cuts the polymer strand 4 into a polymer granulate 6. The unit formed of the cutting means 10 and the sensor 6 is jointly movable in the axial direction, parallel to the movement direction 24 of the polymer strand 4.

The device of FIG. 2 further comprises a control unit 18 to which the sensor 16, the cutting means 10 and the cooling unit 14 are connected. The temperature of the polymer strand 4, which is measured by the sensor 16 continuously or at intervals, serves as control variable for controlling and adjusting the cutting means 10 and/or the means 12 for cooling the polymer strand 4, i.e. in particular the cooling unit 14.

In particular, the position of the cutting means 10 along the travel length 20 is adjustable, and thus the position where the polymer strand 4 is cut. In addition or as an alternative to this, the temperature of the means for cooling the polymer strand 4 can be adjusted by the cooling unit 14.

A method according to the present disclosure can be carried out in the device of FIG. 1 as follows:

A polymer strand 4 is continuously produced in the means 8 for producing a polymer strand 4, from a polymer melt 2 located in the means 8. The polymer strand 4 is continuously moved in the movement direction 24. This is accomplished by a drawing device integrated in the cutting means 10 (not shown). Corresponding embodiments are known from the prior art. After the hot and liquid polymer strand 4 has emerged from the means 8 for producing the polymer strand 4 it is cooled down and, downstream of the cooling section 22, cut into a polymer granulate 6 by the cutting means 10. By moving the cutting means 10 the distance relative to the means 8 for producing the polymer strand 4 is adjusted so as to obtain a preferably minimized travel length 22.

In the preferred embodiment according to FIG. 2 the method additionally comprises the step of cooling the polymer strand 4 in a water cooling bath 12, which is cooled by the cooling unit 14. The cooling step takes place between the step of producing the polymer strand 4 and the cutting step. The method further comprises a step of measuring the temperature of the polymer strand 4 immediately prior to the cutting step, by means of a non-contact, optical temperature measurement using a sensor 16. The measured temperature values are recorded continuously or at intervals and are employed in an adjustment step, in which the temperature of the polymer strand immediately prior to the cutting step is used as control variable. Moving the cutting means 10 adjusts the distance relative to the means 8 for producing the polymer strand 4 so as to obtain a preferably minimized travel length 22. Additionally or alternatively, the cooling temperature of the means 12 for cooling the polymer strand 4 is adjusted by the cooling unit 14.

1. A device for the production of a polymer granulate, comprising a means for continuously producing a polymer strand from a polymer melt and a cutting means for cutting the resultant polymer strand, the cutting means being arranged relative to the means for producing the polymer strand in a distance-variable manner.

2. The device according to claim 1, wherein the device is a screw kneading and extrusion device with a downstream solid-strand granulator.

3. The device according to claim 1, and further comprising a means for cooling the polymer strand which is at least partially arranged between the means for producing the polymer strand and the cutting means.

4. The device according to claim 1, and further comprising a sensor for determining the temperature of the polymer strand directly ahead of the cutting means.

5. The device according to claim 4, wherein the cutting means and the sensor are embodied as one unit, which is movable in an axial direction relative to the means for producing the polymer strand.

6. The device according to claim 4, and further comprising a control unit by means of which one of the means for cooling the polymer strand, a position of the cutting means, and a combination thereof are adjusted.

7. The device according to claim 1, wherein the polymer is a thermoplastic polymer.

8. A method for the production of a polymer granulate, comprising continuously producing a polymer strand from a polymer melt and of cutting the resultant polymer strand into a polymer granulate, and variably adjusting the period between the production of the polymer strand and the cutting step by varying the distance of a cutting means relative to a means for producing the polymer strand.

9. The method according to claim 8, wherein the method is a screw kneading and extrusion method with a downstream solid-matter granulation.

10. The method according to claim 8, and further comprising cooling the polymer strand, the cooling being carried out at least partially between the step of producing the polymer strand and the cutting step.

11. The method according to claim 10, and further comprising measuring the temperature of the polymer strand immediately prior to the cutting step.

12. The method according to claim 11, and further comprising a control step, in which one of the cooling temperature of the means for cooling the polymer strand, a distance between the means for producing the polymer strand and the cutting means, and a combination thereof is adjusted by a movement of the cutting means, wherein the temperature of the polymer strand immediately prior to the cutting step is used as control variable.

13. The method according to claim 8, and wherein the polymer is a thermoplastic polymer.

14. The method according to claim 12, wherein the cooling temperature of the means for cooling the polymer strand, a distance between the means for producing the polymer strand and the cutting means, and a combination thereof is adjusted in such a way that the time-related temperature variation of the polymer strand immediately prior to the cutting step is in the range of 50° C. or less.

15. The device according to claim 3, wherein the means for cooling the polymer strand comprises one of a water cooling bath and a cooling unit.

16. The device according to claim 4, wherein the sensor comprises a non-contact, optical temperature sensor.

17. The device according to claim 7 wherein the thermoplastic polymer is selected from the group consisting of polyesters, polystyrenes, polyolefins, polyamides, polycarbonates, and copolymers thereof.

18. The device according to claim 7, wherein the thermoplastic polymer is redacted from the group consisting of Polyethylene terephthalate, polypropylene, polyethylene, and copolymers thereof.

19. The method according to claim 10, wherein the cooling is performed by water cooling.

20. The method according to claim 11, wherein the measuring the temperature is performed by means of a non-contact, optical temperature measurement.

21. The method according to claim 13, wherein the thermoplastic polymer is selected from the group consisting of polyesters, polystyrenes, polyolefins, polyamides, polycarbonate, and copolymers thereof.

22. The method according to claim 13, wherein the thermoplastic polymer is selected from the group consisting polyethylene terephthalate, polypropylene, polyethylene, and copolymers thereof.

23. The method according to claim 14, wherein the time related temperature variation is 30° C. or less.

24. The method according to claim 21, wherein the time related temperature variation is 10° C. or less.
